(19) United States
(12) Patent Application Publication
(10) Pub. No.: US 2010/0015315 A1
(43) Pub. Date: Jan. 21, 2010

(54) EDIBLE FILM-SHAPED PREPARATION WITH COLA TASTE

(75) Inventors: Hans-Rainer Hoffmann, Neuwied (DE); Bodo Asmussen, Bendorf-Sayn (DE); Holger Piotrowski, Weissenthurm (DE); Markus Müller, Troisdorf (DE)

Correspondence Address: D. PETER HOCHBERG CO. L.P.A., 1940 EAST 6TH STREET, CLEVELAND, OH, 44114, US

(73) Assignee: LTS Lohmann Therapie-Systeme AG, Andernach (DE)

(21) Appl. No.: 12/448,457

(22) PCT Filed: Dec. 12, 2007
(86) PCT No.: PCT/EP2007/010888

§ 371 Date: Sep. 22, 2009

(30) Foreign Application Priority Data
Dec. 22, 2006 (DE) 10 2006 061 287.6

(51) Int. Cl. A23L 1/0522; A23L 1/221

(52) U.S. Cl. 426/534; 426/578

(57) ABSTRACT

The invention relates to edible film-shaped cola-flavoured preparations which disintegrate quickly and without leaving a residue when coming in contact with moisture.

### CROSS-REFERENCE TO RELATED APPLICATIONS

This application is a National Stage application of International Application No. PCT/EP2007/010888, filed on Dec. 12, 2007, which claims priority of German application number 10 2006 061 287.6, filed on Dec. 22, 2006, both of which are incorporated herein by reference in their entireties.

### BACKGROUND OF THE INVENTION

1. Field of the Invention

The present invention relates to edible film-shaped preparations with cola flavour which on contact with moisture disintegrate quickly and without leaving a residue.

2. Description of the Prior Art

The present invention relates to the field of confectionary and snack foods for human consumption. Usually, confectionery is offered for sale in the form of bars, bonbons, chewing sweets, chewing gums, crisps, biscuits and the like, in a multitude of flavours. Most of these products have to be chewed or sucked to produce the desired taste experience in the consumer. For this reason, consuming these products is comparatively conspicuous and is considered inappropriate on many occasions, for example during lessons or in meetings. That they are bulky in the pockets of trousers, shirts or jackets, that they may lead to unwanted dirtying, and that they leave a sensation of having bits or crumbs in one's mouth and/or on one's teeth are considered to be further disadvantages of conventional confectionery.

Wafer-thin strips that leave a cool and fresh-breath taste sensation on the tongue without being chewed or sucked are known. They are sold on the market in the flavours “Peppermint”, “Wild-Mint” and “Lemon-Frost” by the company Wrigley under the name ECLIPSE FLASH™, or in the flavours “COOL MINT®”, “FRESHBURST®”, Cinnamon and “Fresh Citrus” by the company Pfizer under the trade name Listerine POCKETPAKS®, for example.

The patent application published under the publication number US Publication No. 2003/0224090 A1 describes snacks in the form of orally soluble edible films which include one or more layers of film and which are to disintegrate in the oral cavity quickly and without leaving a residue. Although this patent application mentions many natural and artificial flavourings that may be contained in the described edible films based on film-forming polymers to produce a taste experience in the consumer, that document does not contain any reference to cola flavours.

To be able to provide a film-shaped preparation that upon contact with moisture, particularly on contact with saliva, quickly dissolves in the mouth and leads to a refreshing cola flavour experience, the process solvent water, which can be used in the production of films that dissolve quickly and without residue in aqueous media, was, in a first trial series, replaced by cola, which is available via retail trade as a refreshment drink (see Example 1).

However, as it turned out in these trials, the wafers resulting from this method had no or only a scarcely perceivable cola flavour. Possibly, the cola portion contained in the wafer was too small to lead to a satisfying taste experience. The portion of process solvent, however, cannot be increased indefinitely because the solvent- and polymer-containing mass has to have a minimum viscosity before it can be spread on a support for further processing into edible films.

Concentrating the flavour compounds of the refreshment drinks by withdrawing water (e.g., by distilling off) does not lead to satisfactory results. Given the quantity to be used in order to achieve a pleasant taste experience, the high sugar content of the refreshment drink—and hence in the concentrate derived therefrom—may lead to the occurrence of incompatibilities in the film. For example, the sugar may crystallize. Trials with sugar-free “light” variants of the refreshment drinks showed unmistakably that important flavour components are removed along with the water, which in turn is detrimental to the taste experience.

Expecting that it should be possible to avoid the loss of flavour compounds by concentrating a sugar-free or sugar-reduced version of the cola drink, in another trial series, a commercially available cola concentrate was used, which is a syrup that is to be diluted with a predetermined quantity of water to prepare a refreshment drink. According to the directions for use, 18 litres of the drink can be made using 500 ml of the cola syrup. Wafers which had been produced using this syrup indeed had a distinct cola flavour, but they also had an unpleasantly sweet taste due to the still high sugar concentration (see Example 2).

Even when using a, likewise commercially available, cola syrup wherein part of the sugar had been replaced by a sweetener, and when using a “light” syrup that contained only sweeteners and no sugar, the portion of sweetener contained in the wafers was high enough for the aftertaste that is typical for the sweeteners contained in the syrups to be perceived as unpleasant.

A further disadvantage was found to be that the edible films made with cola syrup exhibited an undesirable stickiness and softness which made them appear unsuitable as a product in the confectionary field.

Based on these trial results it was, surprisingly, found that edible films having a satisfactory cola flavour and considerably better haptic properties and which disintegrate in the mouth quickly and without leaving a residue, can be produced by using cola flavourings as used in the food industry for flavouring ice cream, bakery products or mixed drinks.

### SUMMARY OF THE PRESENT INVENTION

The object of the present invention was therefore to provide a product that does not exhibit the above-mentioned disadvantages, results in a refreshing taste experience, approximating that of a draught of cola, and offers a pleasant mouthfeel.

This object is achieved by providing an edible, film-shaped preparation (referred to as “wafer” in the following), with a cola flavour, which on contact with moisture disintegrates quickly and without leaving a residue.

### DETAILED DESCRIPTION OF THE PRESENT INVENTION

The wafers according to the invention comprise as essential components at least one film-forming polymer and at least one cola flavouring. To achieve the desired physical properties of the film-shaped preparation, for example the flexibility thereof, additionally, at least one emulsifying component and/or a plasticizing component is/are necessary. However, certain ingredients of a film-shaped preparation may have several properties, even where these polyfunctional compounds are actually used for a different purpose. Thus, the film-forming polymer polyvinyl alcohol (PVA) also has emulsifying properties, or the sweetener sugar can, in addition, serve as a plasticizer in formulations. Hence, it is possible to realize film-shaped preparations that do not contain a separate emulsifier or plasticizer. Consequently, separate emulsifiers and plasticizers are not to be regarded as essential components of the inventive film-shaped preparations. However, in preferred embodiments, the wafers contain at least one emulsifier, at least one plasticizer, at least one acidifying agent, one or more sweeteners, at least one colouring, one or more additional flavourings, one or more fillers and/or at least one preservative, in addition to the film-forming polymer or polymer mixture and the cola flavouring.

The demands placed on the film-forming polymer or on the film-forming polymers used for the film-shaped preparations follow from the object to be achieved. The film-forming polymers, which are the basis for the inventive film-shaped preparations, have to dissolve quickly in the mouth and without leaving a residue. In addition, the film-forming polymers must be compatible with the flavourings used in each case. That is, the film-forming polymer, or the combination of film-forming polymers, has to be able to absorb and stabilize the flavour compounds or taste compounds to a sufficient extent. Furthermore, the film-forming polymers must not have a detrimental effect on the taste experience. The film-forming polymers thus must not have a perceivable taste of their own, nor must they interfere in any other way with the taste experience to be produced by the added flavouring.

Because of the desired, rapid dissolution behaviour of the inventive preparation, the selection of polymers suitable for their production is limited to cellulose derivatives (e.g. sodium carboxymethyl cellulose, hydroxypropylmethyl cellulose, hydroxypropyl cellulose), partially hydrolyzed polyvinyl alcohols, polyvinyl pyrrolidone, gelatine, alginates, polyethylene glycols, as well as water-soluble starch portions and water-soluble starch derivatives such as hydroxypropylated starch, e.g. hydroxypropylated pea starch.

The trials carried out in connection with the instant invention, however, showed that films based on polyvinyl pyrrolidones are tacky and soft, and that films based on partially hydrolyzed polyvinyl alcohol are susceptible to moisture (hygroscopic) and soft. In addition, these films dissolve too slowly. The water-soluble cellulose derivatives resulted in films having satisfactory physical properties, but showed detrimental influences on the cola flavour contained in the films. These cellulose derivatives had a taste of their own that was perceived as disturbing.

Surprisingly, it was found that by using hydroxypropylated tapioca starch it is possible to produce cola wafers which have the desired properties.

Tapioca starch, also called manioc starch, is derived from processed and dried roots of the manioc plant (Manihot utilissima and Manihot palmata). Tapioca starch usually has an amylose content of about 17%-wt. and an amylopectin content of about 83%-wt., in each case relative to the dry weight of the starch. Partially hydrolyzed tapioca starch is used in the food industry as a food additive (E 1440).

With a majority of the flavouring mixtures (cola flavouring, cola syrup), it is possible by using hydroxypropylated tapioca starch to produce a processible mass that can be further processed into stable films. These films dissolve in the mouth in an appropriately short time, leaving no residue, and they also do not interfere with the cola taste experience.

In addition to the tapioca starch, additional film-forming polymers may be used in order to produce processible masses that can be further processed into wafers having the desired properties. Suitable for use as additional film-forming polymers are, preferably, the above mentioned water-soluble cellulose derivatives, partially hydrolyzed polyvinyl alcohols, polyvinyl pyrrolidone, gelatine, alginates, polyethylene glycols, as well as water-soluble starch portions and other water-soluble starch derivatives.

Preferably, the portion of film-forming polymers contained in the film-shaped preparation is 55 to 75%-wt., relative to the dry matter of the film-forming preparation.

Especially preferably, the portion of hydroxypropylated tapioca starch is 55 to 65%-wt. and the portion of one or more additional film-forming polymers contained in the dry mass is 0.01 to 10%-wt.

Flavourings considered suitable for use as the cola flavouring are the concentrates which are being used in the food industry and which are intended for the flavouring of ice cream, bakery goods or mixed drinks. By using these flavourings, the problems arising from an excessively high sugar content, as occurring when cola syrups or cola concentrates are used, can be avoided. Furthermore, it is possible to admix colourings and further taste-imparting components, e.g. caffeine, in a dosage as desired, in order to optimize the wafer. Preferably, the cola flavouring is contained in an amount of 5 to 20%-wt. in the dry matter of the film-shaped preparations.

In preferred embodiments, the wafer contains at least one emulsifier, which additionally improves the mouthfeel and the taste sensation. Preferably, the emulsifier, or the emulsifiers, is/are selected from the group that comprises mono- and diglycerides of edible fatty acids (e.g. unsaturated fatty acids with up to 24 carbon atoms, as well as monounsaturated and polyunsaturated fatty acids with up to 22 carbon atoms), polyethylene glycol ether, sorbitan fatty acid ester, polysorbates, pectins and lecithin. Examples of polyalkylene glycol ethers, so-called fatty alcohol ethoxylates, commercially also available under the name BRIJ®, are polyoxyethylene (2) stearyl ether (BRIJ® 72), polyoxyethylene (4) lauryl ether (BRIJ® 30), polyoxyethylene (10) stearyl ether (BRIJ® 76), polyoxyethylene (10) cetyl ether (BRIJ® 56), polyoxyethylene (20) stearyl ether BRIJ® 78) and polyoxyethylene (23) lauryl ether (BRIJ® 35).

Examples of sorbitan fatty acid esters, commercially also available under the name SPAN®, are sorbitan monolaurate (SPAN® 20), sorbitan monopalmitate (SPAN® 40), sorbitan monostearate (SPAN® 60), sorbitan tristearate (SPAN® 65) and sorbitan monooleate (SPAN® 80). Examples of polysorbates are polyoxyethylene-20-sorbitan monolaurate (polysorbate 20, TWEEN® 20), polyoxyethylene-40-sorbitan monopalmitate (polysorbate 40, TWEEN® 40), polyoxyethylene-60-sorbitan monostearate (polysorbate 60, TWEEN® 60), polyoxyethylene-65-tristearate (polysorbate 65, TWEEN® 65) and polyoxyethylene-80-sorbitan monooleate (polysorbate 80, TWEEN® 80). Furthermore, macrogol glycerol hydroxystearate (poly(oxyethylene)-40-hydrogenated castor oil) is suitable for use as an emulsifier.

The percentage of emulsifier(s) in the dry matter of the film-shaped preparation is preferably between 0 and 7%-wt.

In a preferred embodiment, the inventive film-shaped preparation contains at least one plasticizer improving the flexibility of the edible film-shaped preparation.

The plasticizers suitable for the edible film-shaped preparations are preferably selected from the group which comprises ethylene glycols, polyethylene glycols, dibutyl sebacate, diethyl phthalate, diacetylated monoglycerides, triacetin, tributyl citrate, triethyl citrate, acetyl tributyl citrate, acetyl triethyl citrate, benzoyl benzoate, propylene glycol, castor oil, saccharose, isomalt, mannitol, starch sugars and dexpanthenol.

Especially preferred are water-soluble plasticizers, so as to be freely miscible with the film-forming polymer. Because of the demands placed on the compatibility, the harmlessness and the neutrality with respect to the taste experience, SORBIDEX® and glycerine are especially preferred as plasticizer. The amount of plasticizer contained in the preparation is between 0 and 18%-wt., relative to the dry matter of the film-shaped preparation.

It has been found that the addition of an acidifier is advantageous for the overall taste impression. The sour taste induces the production of saliva so that the sensation of being refreshed is achieved earlier. Suitable for use as acidifiers are, in particular, tartaric acid, ascorbic acid, malic acid, phosphoric acid, lactic acid and citric acid, with citric acid being the especially preferred acidifier. The acidifier may be contained in an amount of 0 to 5%-wt. in the dry matter of the film-shaped preparation.

By selecting and concentrating the sweetener or sweeteners that may be contained in the film-shaped preparation, the properties and the taste of the wafer can be adapted to different requirements and preferences.

Examples of sweeteners that are basically suitable for the production of the inventive wafers are acesulfame, aspartame, cyclamate, saccharin, sorbitol, sucralose (trichlorosucrose), thaumatin, neohesperidin DC or mixtures of these sweeteners.

It is preferred to use sucralose as a sweetener as, unlike saccharin, for example, it has no bitter aftertaste, but a taste that is pleasant.

The sweetener or sweeteners is/are preferably contained in an amount of from 0 to 19%-wt. in the dry matter of the film-shaped preparation.

By adding further flavourings, e.g. caffeine, lemon flavour or lime flavour, the overall taste impression of the inventive wafer can be adapted. The percentage of additional flavours in the dry matter of the film-shaped preparation may amount to up to 3%-wt.

Furthermore, a colouring may be added to the preparation to give the wafers a colour that corresponds, for example, to the characteristic cola colour. Especially suitable for this purpose is caramel colouring. But it is also possible to give any desired colour to the otherwise colourless films by using different colourings.

Preferably, the colouring is contained in an amount of 0 to 2%-wt. in the dry mass of the film-forming preparation.

In a particularly preferred embodiment, the wafer contains caffeine, which has been added to the polymer mass during the production of the wafers. Caffeine is anyway associated with the consumption of cola, and in the wafers according to the present invention it can lead to an improvement in the overall taste impression. Caffeine is preferably contained in the dry matter of the film-shaped preparations in an amount of 0 to 2%-wt.

In addition, 20%-wt. of one or more fillers, e.g. as thickeners, disintegration enhancers or stabilizers, and up to 5%-wt. of one or more preservatives (e.g. antioxidants, crystallization inhibitors and preservative agents acting against microbial spoilage), in each case relative to the dry matter of the film-shaped preparation, may be contained in the wafers according to the invention.

The preferred embodiments of the wafers according to the invention are composed of the following ingredients, in the quantity ranges indicated:

| Content relative to | |
|---|---|
| dry matter (%-wt.) | Component |
| 55-75 | film-forming polymer(or polymer mixture) |
| 5-20 | cola flavouring |
| 0-18 | plasticiser |
| 0-19 | sweetener |
| 0-7 | emulsifier |
| 0-2 | colouring |
| 0-5 | acidifier |
| 0-3 | further flavourings |
| 0-5 | preservatives |
| 0-20 | filler(s) |

By means of trials, compositions having especially preferred properties were determined, wherein the following components were contained in the quantity ranges indicated:

| Content | | |
|---|---|---|
| relative to | | |
| dry matter | | |
| (%-wt.) | Component | Main function |
| 55-65 | hydroxypropylated tapioca starch | film-forming polymer |
| 0-10 | partially hydrolysed polyvinyl alcohol | film-forming polymer |
| 5-20 | cola flavouring | flavouring |
| 5-18 | glycerine | plasticiser |
| 0-18 | sorbitol syrup | sweetener |
| 0-1 | sucralose | sweetener |
| 0-1 | mono- and diglycerides of fatty acids | emulsifier |
| 0-3 | polyethoxylated sorbitan ester | emulsifier |
| 0-3 | macrogol glycerol hydroxystearate | emulsifier |
| 0.2-2 | caramel colouring | colouring |
| 2-5 | citric acid | acidifier |
| 0-1 | lime flavour | flavouring |
| 0.1-2 | caffeine | flavouring |

The taste of the variant indicated in Example 3 has turned out to be exceptionally pleasing.

### Example 1

A polymer-containing mass, consisting of 25%-wt. polyvinyl pyrrolidone and 75%-wt. of a cola drink, available at retailers as a refreshment drink, was prepared, spread onto a support, converted into a film by drying and made into wafers of up to 10 cm² by separating.

This film, however, did not taste of cola.

### Example 2

A mixture of the following composition was prepared:

| Content relative to | |
|---|---|
| dry matter [%-wt.] | Component |
| 10.95 | PVA |
| 0.90 | citric acid |
| 0.12 | TWEEN ® 80 |
| 0.03 | Physcool ® |
| 57.14 | cola syrup |
| 30.86 | water |

This mixture was spread on a support, converted into a film by drying, and made into wafers of up to 10 cm² by separating.

The wafers indeed had a distinct taste of cola, but the taste was unpleasantly sweet.

### Example 3

A mixture was prepared which had the following composition:

| Content | |
|---|---|
| (%-wt.) | Component |
| 28.4 | C*AraSet (hydroxypropylated tapioca starch) |
| 2.5 | Mowiol, 5-6 mPas (partially hydrolysed polyvinyl alcohol) |
| 5.5 | glycerine |
| 5.0 | Sorbidex |
| 0.2 | sucralose |
| 0.3 | ATMOS ® 300 (mono- and diglycerides of edible fatty acids) |
| 0.8 | TWEEN ® 80 (polyethylene sorbitan monooleate) |
| 0.8 | CREMOPHOR ® RH 40 (macrogol glycerol hydroxystearate) |
| 1.7 | E 150 |
| 2.0 | citric acid |
| 0.3 | lime flavouring |
| 0.2 | caffeine |
| 5.0 | cola flavouring |
| 47.3 | water |

This mixture was spread on a support, converted into a film by drying, and made into wafers of up to 10 cm² by separating.

The resulting wafers dissolved in the mouth quickly and without leaving a residue, did not lead to an unpleasantly sticky mouthfeel, and had a refreshing cola taste.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, combinations, modifications, and variations that fall within the spirit and scope of the appended claims.

We claim:

1. An edible, water-soluble, film-shaped preparation containing cola flavouring, wherein said preparation dissolves quickly upon contact with moisture and does not leave a residue, and wherein said preparation contains a film-forming polymer selected from the group consisting of hydroxypropylated starch derivatives, or contains such a polymer in combination with further film-forming polymers.

2. The preparation according to claim 1, wherein said further film-forming polymers are selected from the group consisting of cellulose derivatives, partially hydrolyzed polyvinyl alcohols, polyvinyl pyrrolidone, gelatine, alginates and polyethylene glycols.

3. The preparation according to claim 1, wherein said preparation comprises the following composition:

| | |
|---|---|
| 55-75%-wt. | film-forming polymer (or polymer mixture) |
| 5-20%-wt. | cola flavouring |
| 0-18%-wt. | plasticiser(s) |
| 0-19%-wt. | sweetener(s) |
| 0-7%-wt. | emulsifier(s) |
| 0-2%-wt. | colouring |
| 0-5%-wt. | acidifier(s) |
| 0-3%-wt. | further flavouring |
| 0-5%-wt. | preservative |
| 0-20%-wt. | filler(s). |

4. The preparation according to claim 3, wherein the film-forming polymer mixture comprises
a) 55 to 65%-wt. of a hydroxypropylated starch derivative, and
b) 0.01 to 10%-wt. of one or more further film-forming polymers, which is/are selected from the group consisting of sodium carboxymethyl cellulose, hydroxypropylmethyl cellulose, hydroxypropyl cellulose, partially hydrolyzed polyvinyl alcohols, polyvinyl pyrrolidone, gelatine, alginates, polyethylene glycols, water-soluble starch portions, and water-soluble starch derivatives other than the hydroxypropylated starch derivative mentioned under a).

5. The preparation according to claim 4, wherein the hydroxypropylated starch derivative is selected from the group which comprises hydroxypropylated pea starch and hydroxypropylated tapioca starch.

6. The preparation according to claim 3, wherein the plasticizer(s) is/are selected from the group consisting of ethylene glycols, polyethylene glycols, dibutyl sebacate, diethyl phthalate, diacetylated monoglycerides, triacetin, tributyl citrate, triethyl citrate, acetyl tributyl citrate, acetyl triethyl citrate, benzoyl benzoate, propylene glycol, castor oil, saccharose, isomalt, mannitol, starch sugars and dexpanthenol.

7. The preparation according to claim 3, wherein the emulsifier(s) is/are selected from the group consisting of mono- and diglycerides of edible fatty acids, polyethylene glycol ethers, sorbitan fatty acid esters, polysorbates, pectins, lecithin and macrogol glycerol hydroxystearate.

8. The preparation according to claim 3, wherein the sweetener(s) is/are selected from the group consisting of acesulfame, aspartame, cyclamate, saccharin, sorbitol, sucralose (trichlorosucrose), thaumatin, neohesperidin DC, and mixtures of these sweeteners.

9. The preparation according to claim 3, wherein the acidifier(s) is/are selected from the group consisting of tartaric acid, ascorbic acid, malic acid, phosphoric acid, lactic acid and citric acid.

10. The preparation according to claim 1, wherein said preparation comprises the following composition, relative to the dry matter of the preparation:

| | |
|---|---|
| 55-65%-wt. | hydroxypropylated tapioca starch |
| 0-10%-wt. | partially hydrolysed polyvinyl alcohol |
| 5-18%-wt. | glycerine |
| 0-18%-wt. | sorbitol syrup |
| 0.2-1%-wt. | sucralose |
| 0-1%-wt. | mono- and diglycerides of fatty acids |
| 0-3%-wt. | polyoxyethylene sorbitan monooleate |
| 0-3%-wt. | macrogol glycerol hydroxystearate |
| 0.2-2%-wt. | caramel colouring |
| 2-5%-wt. | citric acid |
| 0-1%-wt. | lime flavouring |
| 0.1-2%-wt. | caffeine |
| 5-20%-wt. | cola flavouring. |

11. The preparation according to claim 9, wherein said preparation comprises the following composition, relative to the dry matter of the preparation:

| | |
|---|---|
| 56.9%-wt. | hydroxypropylated tapioca starch |
| 5.0%-wt. | partially hydrolysed polyvinyl alcohol |
| 11.0%-wt. | glycerine |
| 7.0%-wt. | sorbitol syrup |
| 0.5%-wt. | sucralose |
| 0.5%-wt. | mono- and diglycerides of edible fatty acids |
| 1.5%-wt. | polyoxyethylene sorbitan monooleate |
| 1.5%-wt. | macrogol glycerol hydroxystearate |
| 1.2%-wt. | caramel colouring |
| 4.0%-wt. | citric acid |
| 0.5%-wt. | lime flavouring |
| 0.4%-wt. | caffeine |
| 10.0%-wt. | cola flavouring. |

12. Use of cola flavouring, in combination with a film-forming and water-soluble, hydroxypropylated starch derivative, for producing an edible, water-soluble film-shaped preparation which dissolves quickly upon contact with moisture and does not leave a residue.
